(19) United States
(12) Patent Application Publication
(10) Pub. No.: US 2007/0176782 A1
(43) Pub. Date: Aug. 2, 2007

(54) Device location system and method

(76) Inventor: Swarup Kumar Mohalik, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,799

(22) Filed: Jul. 24, 2006

(30) Foreign Application Priority Data
Aug. 8, 2005 (IN) IN1098/CHE/2005

(51) Int. Cl. G08B 13/14

(52) U.S. Cl. 340/572.1

(57) ABSTRACT

A device location system is described including a position beacon associated with a specified physical location, a beacon detection means attached to or physically associated with said device, the beacon detection means adapted to actively interrogate its surrounding environment to detect the presence of a proximate position beacon and record the presence of said position beacon thereby correlating the location of the device with the specified physical location. The invention also provides a device incorporating beacon detection means, for example an RFID reader.

### BACKGROUND TO THE INVENTION

Tracking the location of electronic hardware, in particular information technology (IT) hardware, generically termed “resources”, is an essential task in the management of an organisation's IT infrastructure. This is particularly so in large organisations with various articles of electronic hardware deployed at dispersed geographical and physical locations. For example, in an organisation or enterprise with a nominal IT infrastructure the IT resources may be locally deployed at various locations within a campus or in a single building. For international organisations with a large IT infrastructure the IT resources may be deployed at remote geographical locations thus making identification and administration of the resources difficult.

The IT resources contemplated by the invention include computing and computing-related devices such as servers, desktop computers, laptop computers and routers as well as peripherals and mobile devices such as printers, scanners, personal digital assistants (PDAs) and the like.

When managing an IT infrastructure it is important that an administrator or engineer as well as users be able to accurately and rapidly identify and locate a specified IT resource. For example, a faulty server may be identified to the engineer by its internet protocol (IP) address which, unless the domain name system (DNS) record has associated LOC data, provides no information relating to the physical location of the server. Similarly, knowing the IP address or network name of a peripheral, for example a printer, rarely helps a user find the printer which is closest to their workstation or the appropriate printer from which to collect his or her printout. Thus, location determination of IT resources is important in the day to day functions of users and administrators alike.

Most current methods for preparing a location inventory of IT resources are either completely manual or only semi-automatic. Often collecting location information will be as unsophisticated as noting the physical location of a device and recording this against its IP address in a written table in the hope that the device is not subsequently moved in the absence of the administrator or engineer. Semi-automatic identification techniques include those where unique barcodes are attached to the devices and they are scanned and a device identifier recorded in a database against the manually determined location. This data can be made available by means of a system-wide database which may be part of IT-management software, for example the OpenView software product developed by the applicant. Again, the ongoing accuracy of this technique relies on the object or device not being moved.

Manually locating and recording the location of each IT resource can be an extremely time-consuming task. This process can also be error prone and it is likely that the location data will only be current for a relatively short time. At best, a location database represents a snapshot of the physical deployment of the IT infrastructure during the period when the audit was performed. Further, much modem IT infrastructure is reasonably lightweight and portable. Thus resources may be moved by users without informing IT administration, thus compromising the accuracy of an equipment location database.

There exist solutions for tracking objects based on Radio Frequency Identification (hereafter referred to as RFID) technology. This technology operates by means of passive (un-powered) or active (powered) RFID devices or tags which emit a signal when activated (for example, inductively or capacitively) by the electromagnetic field of a proximate RFID reader.

One technique involves positioning an RFID tag reader in a fixed position, for example in a doorway or in an office, and attaching an RFID tag to the object which is required to be tracked. As the object is carried or moved past the reader, the reader detects the presence of the RFID tag and records the fact of its proximity to the reader as well as the readers identity and thus the transitory physical location of the RFID tag can be recorded. While this technique is an improvement over prior art methods, it requires that a separate RFID reader infrastructure be deployed. Such an infrastructure would include power, hardware and data communications functions configured to interface with an asset/resource location management system.

Accordingly, there exists a need to be able to determine the location of IT resources in a way which is efficient, rapid and preferably in a manner which dispenses with or minimises the manual work involved in physically determining the location of the resources and building an accessible resource/equipment location database. It is also desired that the problems of the semi-automatic techniques described above are ameliorated.

### BRIEF DESCRIPTION OF THE DRAWINGS

The invention will now be described by way of example only and with reference to the drawings in which:

FIG. 1: illustrates a position detection system for rack-mounted servers;

FIG. 2: illustrates a position detection system for a workstation;

FIG. 3: illustrates a simplified schematic of a location sensing; and

FIG. 4: illustrates a schematic high-level view of a software system adapted for location.

### DISCLOSURE OF THE INVENTION

There will be described a device location system comprising a position beacon associated with a specified physical location; and a beacon detection means attached to or physically associated with said device, said beacon detection means adapted to actively interrogate its surrounding environment to detect the presence of the position beacon when the beacon detection means is proximate said position beacon, and record information relating to the presence of said position beacon thereby correlating the location of the device with the specified physical location.

The position beacon is preferably passive in the sense that it transmits a signal notifying its presence when interrogated by a proximate beacon detection means.

In some embodiments, the detection range of the position beacon to the beacon detection means may be configured to selectively allow the detection of one or more out of a plurality of position beacons.

The position beacon is preferably powered by means of an interrogation signal emitted by a proximate beacon detection means.

The position beacon may be a Radio Frequency Identification (RFID) tag located so as to be associated with a specified physical location.

The beacon detection means may be a Radio Frequency Identification (RFID) reader physically associated with the device.

The RFID reader may be adapted to be powered by and/or integrated into the device.

The RFID reader may be adapted to periodically interrogate its surroundings and record the presence of any proximate position beacons.

The RFID reader may be further adapted to store data relating to the identification of any proximate position beacons internally in said device, preferably in a manner, form or format which can be queried by a remote management device.

The RFID reader may be alternatively adapted to communicate data relating to the identification of any proximate position beacons to one or more remote management devices.

The RFID tag and/or reader may be configured so that the reader records the presence of the RFID tag at or within a specified range.

The specified range is preferably chosen to reflect the required positioning accuracy in respect of the deployed device.

The RFID reader may include a serial output which is connected to a serial port associated with the device.

The device preferably is adapted to support a communication protocol which is configured to allow retrieval of the position beacon data.

Ideally, the communication protocol is a management protocol adapted to expose or communicate device parameters in response to a specified command.

Preferably the communication protocol is the Simple Network Management Protocol (SNMP), Web Based Enterprise Management (WBEM) and the like.

The location sensing functions of the devices are preferably governed by a control module, the control module comprising means to periodically interrogate the devices environment;
read the RFID readers output, and
store the RFID readers output.

Preferably, the control module is further adapted to interpret the RFID readers output and internally set the value of a parameter configured according to said communication protocol thereby allowing retrieval of the position beacons identifying data and hence position of the device.

In a preferred embodiment, the control module comprises a configuration file specifying the interrogation interval; a serial i/o module adapted to invoke the interrogation function of the RFID reader at the specified interval; and a storage module adapted to extract and interpret the data output from the RFID reader, said data including the beacon device location identifier and hence invoke a command to set the value of an SNMP specific attribute which can be used to extract the identifier of the position beacon and hence the location of the device.

The position beacon is preferably adapted to be programmed with location identifying data using an RFID reader/writer.

Also described will be a device incorporating a position beacon detection means, the beacon detection means preferably adapted to store physical location information read from a position beacon in a manner, form or format which allows it to be retrieved by a remote management means.

A method will also be described of managing the location of a plurality of devices including the step of querying one or more of the devices to retrieve location information stored in said devices, said location information obtained by said devices by detecting the presence of one or more proximate position beacons, the position beacons containing location information corresponding to the physical location of said position beacons.

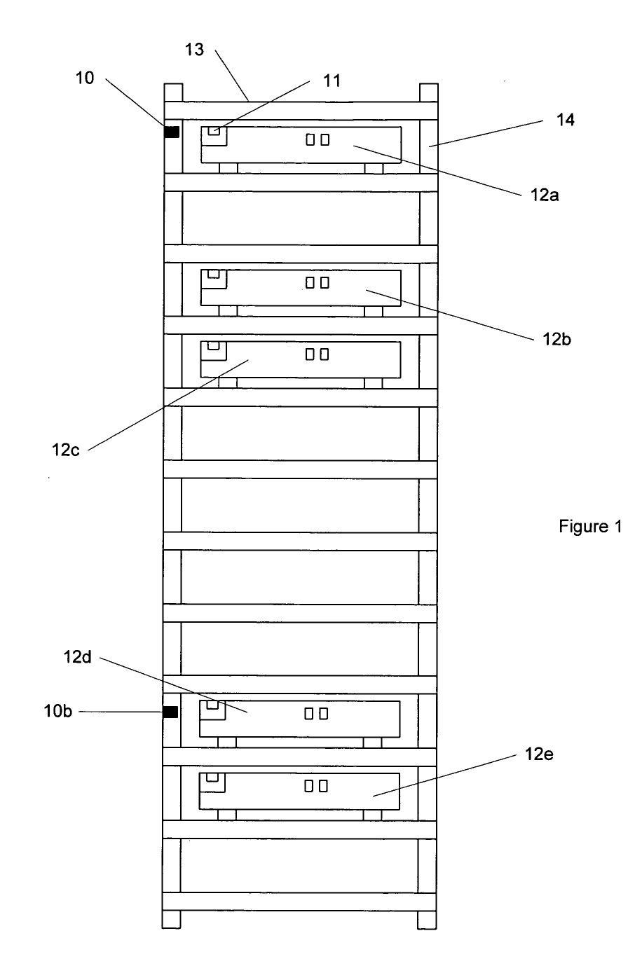

FIG. 1 illustrates an embodiment of a device location system including a position beacon 10, which in the embodiment illustrated corresponds to a RFID tag. This tag is associated with a specified physical location, here a bay and shelf in a rack-mounted server installation. The device 12a is a rack-mounted server. The embodiment illustrated includes a beacon detection means 11, in this embodiment a RFID reader attached to or physically associated with the server 12a. The RFID reader 11 is adapted to actively interrogate its surrounding environment to detect the presence of a proximate RFID tag 10 and record the presence of the tag 10 thereby correlating the location of the server 12a with the specified physical location in the rack 14. The RFID tag has the data identifying the specific location stored therein. This data can be formatted to conform to a naming convention that may be adopted or defined in the particular enterprise or organisation. For example, this may be in the form “Site-Room-Desk-ID-No” or the like. The particular data format may depend on the particular physical environment and can include broader location data such as Geography-Country-City-Site. The embodiment shown in FIG. 1 relates to the placement of IT resources or devices in the form of rack-mounted servers located in regularly spaced racks and slots. It is required that each server be ‘aware’ of its position and in this embodiment the location data string format is defined thus: Room Name-Rack Number-Slot Number.

The RFID reader 11 may be attached to the exterior of the server chassis 12a or alternatively integrated into the server electronics itself (not shown). In this example, the range of the RFID reader is configured so that the reading range is limited to a specific relatively small distance which is suitable for the location detection context concerned. In this case, the range is such that a RFID reader 11 associated with a server 12a is able to only read RFID tag 11 which is in the proximity of the server bay/mount position 14. In the case of the example shown in FIG. 1, it is envisaged that low frequency tag/reader combinations would be used as they have the requisite short reading range. For larger beacon/reader separations, position beacons in the form of RFID tags 10 may be high frequency (13.56 MHz) read/write tags. In general, a suitable tag type is that manufactured by Texas Instruments, the Tag-IT HF card which includes 256 bit memory.

Using an RFID writer and its programming toolkit, the location data (Room Name-Rack Number-Slot Number) is written into the user portion of the RFID tag memory. The tag is then fixed at the specified slot and rack in the chosen room.

A RFID reader, for example one manufactured by RightTag and compatible with the Tag-IT RFID tags used for the position beacon 10, is attached to or integrated into .the server 12a which is to be positioned in the particular slot and rack in the selected room.

Other position beacons 10b are similarly located in the other bays/slot positions in the rack. Thus, if the server 12a is moved to the position indicated by the server 12d in FIG. 1, the reader 11 reads the new position by means of the short-range interaction between the reader 11 and the tag 10b mounted in the corresponding rack bay.

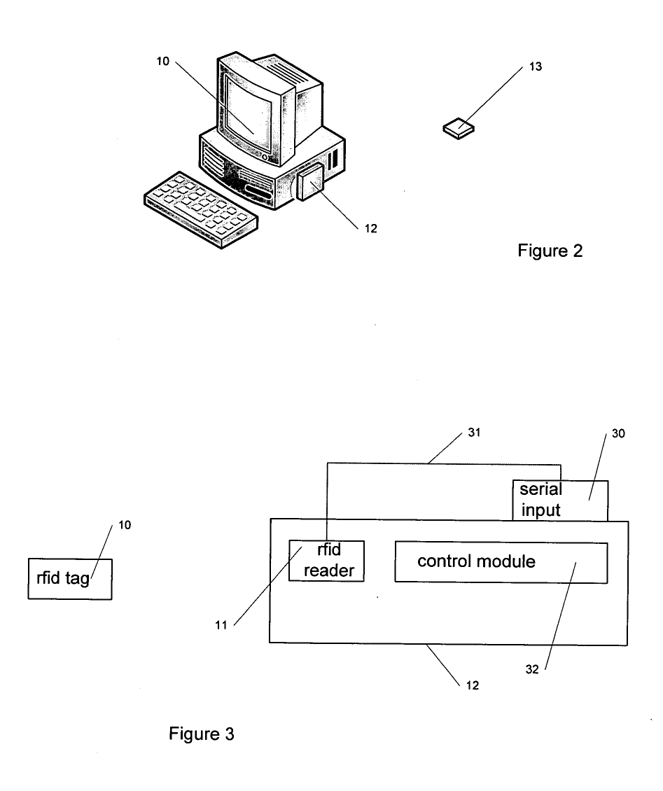

FIG. 2 illustrates a workstation or desktop computer embodiment. Here, it is envisaged that high frequency RFID read/write hardware would be used as these component combinations will have the longer ranges appropriate to this spatial context.

To this end, FIG. 2 illustrates a single desktop computer 10 which has a RFID reader 12 associated therewith. A RFID tag 13 is located in physical association with the vicinity, for example the physical desktop or office. In this example, the RFID reader may be attached to the outside of the desktop computer case and its output connected to the serial input port of the computer (not shown).

In the embodiments shown, the RFID readers 11 and 12 in FIGS. 1 and 2 respectively have a serial output which is connected directly to a serial input of the device; that is, the server or desktop PC. A software module in the device monitors the serial input either continuously or periodically, and extracts data identifying the tag and/or the physical location data which is read by the reader from any proximate tags.

The control module then stores this location data in the device in a specified form so that remote devices can query the device and thereby determine its physical location. This is explained in detail as follows.

In the case of FIG. 1 and with reference to FIG. 3, the serial I/O port of the reader 11 is connected to the serial input port of the server 30. The software control module 32 is uploaded to the server and is executed. In the present embodiment, the server 12a runs the Linux operating system and an SNMP (simple network management protocol) daemon “snmp” to act as a SNMP server. Most network devices such as printers which do not have console support do however support SNMP. The selection of SNMP is considered particularly suitable for setting and getting the physical location information from the RFID reader. Other communication protocols are viable such as WBEM (web based enterprise management).

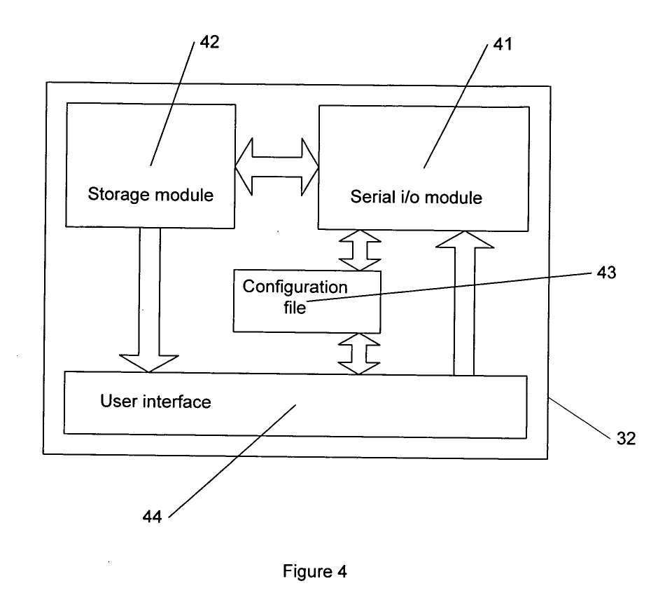

The control module 32 is shown schematically in FIG. 4 and consists of the following components.
A configuration file 43. This file contains data which specifies the interrogation or reading frequency which controls how frequently the RFID reader queries any RFID tags which may be in the devices proximity. In the embodiment described above in FIG. 1 this would cause the reader to periodically read the location code embedded in the tag 10 at an interval defined by the data in the configuration file. By convention, if the data in the configuration file is “0”, the RFID reader queries the RFID tags in its proximity continuously.
Serial I/O module 41. This module invokes the “read” function of the RFID reader device at the interval specified by the configuration file 43 and reads the embedded tag data through the serial port 30 (FIG. 2).
A storage module 42. This module extracts the location information (for example: Room Name-Rack Number-Slot Number) from the user part of the RFID data which is obtained from serial I/O module 41.

The module then invokes the command:

snmpset -v2c-c testing localhost system.sysLocation.0 s “Room Name-Rack Number-Slot Number”

This command and arguments sets the value of an SNMP-specific attribute (sysLocation) which can be used to retrieve the location of the device. The string “testing” is a community string which is configured in the file /etc/snmp/snmpd.conf to have authorisation to change the attribute system.sysLocation.0. The SNMP Community string is similar to a user id or password that allows access to a device's statistics. If the community string is correct, the device responds with the requested information. If the community string is incorrect, the device simply discards the request and does not respond. The community strings can be set to have read-only or read-write access for the system information managed by SNMP.

A remote user or device can then invoke the command:

snmpget -c public x.y.z.w system.sysLocation.0

to get the current value of location stored in the SNMP variable system.sysLocation.0 of the device with x.y.z.w as its IP address.

The control module 32 may also include a user interface module 44 which is used to set and read the interrogation periodicity in the configuration file 43 and to read the sysLocation value locally using snmpget with the default local IP address.

The present system therefore provides a mechanism by which a suitably configured device can be made “aware” of its location using a minimal number of additional components and with low management overhead. The position beacons in the embodiments described may be passive and do not require any power source. RFID tags are also relatively cheap, long-lived and can be rewritten thereby allowing them to be reused.

This technique further allows IT resources to be made aware of their location in such a way that remote users can easily and effectively obtain the location information, preferably by means of accepted protocols such as SNMP. To this end, the specific embodiment's use of the SNMP protocol and associated functionalities allows the immediate integration of the technique with legacy IT infrastructures thereby leading to significant cost savings in terms of deployment of the location detection system.

The technique described herein is automatic in the sense that depending on the polling frequency of a devices beacon reader, if the device is moved to a new location which has a beacon, its position awareness is updated automatically and is immediately exposed to the corresponding management or administration tools via the snmpget command. Thus, the location detection technique is dynamic and adapts to movement of devices in the IT infrastructure.

Also, by mixing readers and beacons of different ranges, devices can track their own location at varying levels of granularity and possibly by reading more than one beacon at a time with different location accuracy. Contention between beacons may invoke contention rules in cases of conflict or multiple beacon detection, relying on signal strength or predetermined location consistency rules built into the management database. This information may be used to accurately locate the device within the physical environment.

Advantageously, the reading devices can be supplied with power by means of the IT-resource or device itself.

In further embodiments it may also be possible to exploit the ability to package environmental sensors with the position beacon itself. For example, it is possible to incorporate temperature or humidity sensors with the RFID package. This would allow the reader to interrogate the beacon for a range of environmental data which could then be exposed to remote users or management software by means of an extended SNMP MIB (management information base) configured to include variables for these parameters. These modifications are considered within the scope of the present invention.

It is also possible that other methods for connecting the reader to the device are viable, particularly if they are integrated or embedded with the device hardware. For example, the Intelligent Platform Management Interface (IPMI), which provides a specification for reading different system parameters such as temperature, voltage, fan speed and chassis intrusion, may be modified to additionally include the sensed location information. This information would then be fed to a Baseboard Management Controller (BMC) from the RFID reader which can be viewed as yet another type of sensor.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A device location system comprising:
a position beacon associated with a specified physical location; and
a beacon detection means attached to or physically associated with said device, said beacon detection means adapted to actively interrogate its surrounding environment to detect the presence of the position beacon when the position beacon is proximate the beacon detection means, and record information relating to the presence of said position beacon thereby correlating the location of the device with the specified physical location.

2. A device location system as claimed in claim 1 wherein the detection range of the position beacon to the beacon detection means is configured to selectively allow the detection or one or more out of a plurality of position beacons.

3. A device location system as claimed in claim 1 whereby the position beacon is powered by means of an interrogation signal emitted by a proximate beacon detection means.

4. A device location system as claimed in claim 1 wherein the position beacon is a Radio Frequency Identification (RFID) tag located so as to be associated with a specified physical location.

5. A device location system as claimed in claim 1 wherein the beacon detection means is a Radio Frequency Identification (RFID) reader physically associated with the device.

6. A device location system as claimed in claim 1 wherein the beacon detection means is configured to periodically interrogate its surroundings and record the presence of any proximate position beacons.

7. A device location system as claimed in claim 1 wherein the beacon detection means is further adapted to store data relating to the identification of any proximate position beacons internally in said device, in a manner, form and format which can be queried by a remote management device.

8. A device location system as claimed in claim 1 wherein the beacon detection means is adapted to communicate data relating to the identification of any proximate position beacons to one or more remote management devices.

9. A device location system as claimed in claim 1 wherein the position beacon and/or the beacon detection means is configured to record the presence of a position beacon to a beacon detection means at or within a specified range.

10. A device location system as claimed in claim 9 wherein the specified range is chosen to reflect the required positioning accuracy in respect of the deployed device.

11. A device location system as claimed in claim 1 wherein the beacon detection means includes a serial output which is connected to a serial port associated with the device.

12. A device location system as claimed in claim 1 wherein the device is adapted to support a communication protocol configured to allow retrieval of the position beacon data.

13. A device location system as claimed in claim 1 wherein the functions of the device are governed by a control module, the control module comprising means to periodically interrogate the devices environment;
read the beacon detection means output, and store the beacon detection means output.

14. A device location system as claimed in claim 13 wherein the control module is further adapted to interpret the beacon detection means output and set the value of a parameter configured according to a communication protocol thereby allowing retrieval of the beacons identifying data and hence position of the device.

15. A device location system as claimed in claim 13 wherein the control module comprises:
a configuration file specifying the interrogation interval;
a serial i/o module adapted to invoke the interrogation function of the beacon detection means at the specified interval; and
a storage module adapted to extract and interpret the data output from the beacon detection means, said data including the beacon device location identifier and hence invoke a command to set the value of an SNMP specific attribute which can be used to extract the identifier of the position beacon and hence the location of the device.

16. A device location system as claimed in claim 1 wherein the position beacon is adapted to be programmed with location identifying data using a beacon detection means configured to write data to a position beacon.

17. A device location system as claimed in claim 1 wherein the position beacon is additionally adapted to sense a plurality of environmental parameters which can be included in the data communicated when the beacon is interrogated by a beacon detection means.

18. A device including a beacon detection means configured to actively interrogate its surrounding environment to detect the presence of a proximate position beacon, said beacon associated with a specified physical location, and record information relating to the presence of said position beacon thereby correlating the location of the device with the specified physical location.

19. A device as claimed in claim 20 wherein the beacon detection means is adapted to store the physical location information read from a position beacon in a manner, form or format which allows it to be retrieved by a remote management means.

20. A method of managing the location of a plurality of devices including the step of querying one or more of the devices to retrieve location information stored in said devices, said location information obtained by said devices by detecting the presence of one or more proximate position beacons, the position beacons containing location information corresponding to the physical location of said position beacons.
